(19) United States
(12) Patent Application Publication
(10) Pub. No.: US 2026/0083139 A1
(43) Pub. Date: Mar. 26, 2026

(54) METHOD AND APPARATUS FOR THERMAL TREATMENT OF POULTRY APPENDAGES

(71) Applicant: MOUNTAIRE CORPORATION, Little Rock, AR (US)

(72) Inventors: Scott Edwin Hevner, Laurel, DE (US); Scott Allen Thompson, Millsboro, DE (US); Scott Shannon Ballweg, Lewes, DE (US); Michael A. Davidson, JR., Delmar, DE (US); Alling Hendron Yancy, Apex, NC (US)

(73) Assignee: MOUNTAIRE CORPORATION, Little Rock, AR (US)

(21) Appl. No.: 19/406,442

(22) Filed: Dec. 2, 2025

Related U.S. Application Data
(62) Division of application No. 18/384,690, filed on Oct. 27, 2023.
(60) Provisional application No. 63/463,214, filed on May 1, 2023.

(51) Int. Cl. A22B 5/00; A22C 21/00

(52) U.S. Cl. CPC A22B 5/0076; A22C 21/00

(57) ABSTRACT

A method and apparatus are provided for thermal treatment of poultry appendages, such as chicken feet or paws. In this regard, the apparatus may include a thermal transport assembly that may be structured and dimensioned to be filled with a thermal treatment liquid (e.g., water, or the like) that is regulated at a designated target temperature. The poultry appendages may be pumped from a picker assembly to the thermal transport assembly such that the appendages are at least partially submerged in the thermal treatment liquid while being transported through the thermal transport assembly. The thermal treatment liquid may be maintained at a specified temperature, and the thermal transport assembly may be operated such that the poultry appendages are at least partially submerged in the thermal treatment liquid for a specified amount of time.

### CROSS-REFERENCE TO RELATED APPLICATIONS

This application is a divisional of U.S. patent application Ser. No. 18/384,690 filed on Oct. 27, 2023, which claims the benefit of U.S. Provisional Application No. 63/463,214, filed on May 1, 2023, the contents of each of which are hereby incorporated by reference herein in their entirety.

### FIELD OF THE INVENTION

The present invention embraces a method and apparatus for thermal treatment of poultry appendages.

### BACKGROUND

There is a need for a safer, more efficient way to thermally treat poultry appendages.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A method and apparatus are provided for thermal treatment of poultry appendages, such as chicken feet or chicken paws. In this regard, the apparatus may include a thermal transport assembly that may be structured and dimensioned to be filled with a thermal treatment liquid (e.g., water, or the like) that is regulated at a target temperature (e.g., designated temperature or temperature range). The poultry appendages may be supplied (e.g., pumped, or the like) from a picker assembly to the thermal transport assembly such that the appendages are at least partially submerged in the thermal treatment liquid while being transported through the thermal transport assembly. The thermal transport assembly may be operated such that the poultry appendages are at least partially submerged in the thermal treatment liquid for a target duration (e.g., designated duration or duration range). By precisely controlling the parameters (e.g., target temperature, target time, thermal treatment liquid level, or the like) for thermal treatment of the poultry appendages, the method and apparatus described herein may thermally treat the poultry appendages such that the pathogen levels are lowered to safe levels while aiding in minimizing any negative effects of the thermal treatment on the final product.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1A illustrates a top-down perspective view of the apparatus for thermal treatment of poultry appendages, in accordance with an embodiment of the present disclosure;

FIG. 1B illustrates a first side perspective view of the apparatus for thermal treatment of poultry appendages, in accordance with an embodiment of the present disclosure;

FIG. 1C illustrates a second side perspective view of the apparatus for thermal treatment of poultry appendages, in accordance with an embodiment of the present disclosure;

FIG. 2 illustrates a process flow for thermal treatment of poultry appendages, in accordance with an embodiment of the present disclosure; and

FIG. 3 illustrates a schematic diagram of an exemplary controller system of the apparatus for thermal treatment of poultry appendages, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

It should be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, “poultry appendages” may refer to various parts or portions (e.g., feet, paws, wings, and/or the like) of a bird (e.g., chicken, turkey duck, goose, guinea, squab, and/or the like) that has been processed or is intended to be processed for human consumption. Though the present disclosure may refer to chicken feet or chicken paws, it should be appreciated by those skilled in the art that the scope of the disclosure with respect to the methods and apparatuses described herein may further be applicable to other parts of a chicken (e.g., gizzard, wing, thigh, breast, and/or the like) or other types of animals (e.g., pig, lamb, cow, deer, and/or the like).

Domestic poultry products, such as chicken paws or feet, may be susceptible to infection by pathogens, such as avian influenza Type A viruses. In response, various governments have promulgated guidelines that define temperatures and durations for heat treating poultry in order to destroy the viral or bacterial infections, thereby making the poultry products safe for consumption. For instance, the export requirements for poultry processing may provide guidelines as provided below:

TABLE 1
Exemplary heat processing requirements for export

| | Core Temperature (° C./° F.) | Time | |
|---|---|---|---|
| Poultry Meat | 60.0/140 | 507 | seconds |
| | 65.0/149 | 42 | seconds |
| | 70.0/158 | 3.5 | seconds |
| | 73.9/165 | 0.51 | seconds |

That said, conventional heat treatment methods for poultry products may cause various unintended effects that may affect the quality of the products. For example, conventional heat treatment methods may affect the structural integrity of the products (e.g., the chicken feet or paws may become deformed, blistered, and/or the like), the flavor and/or texture of the products, and/or the like.

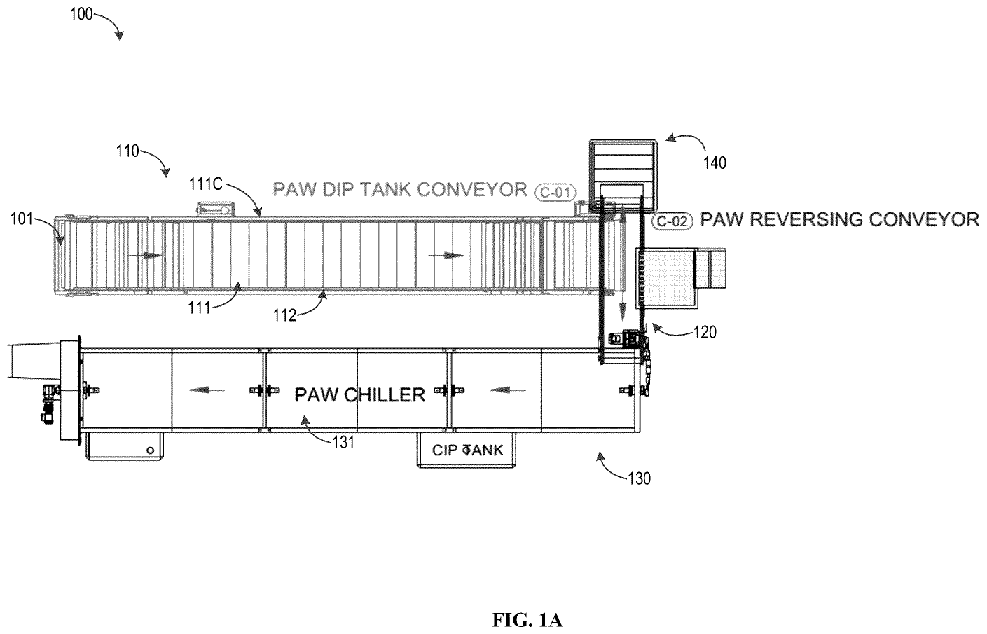

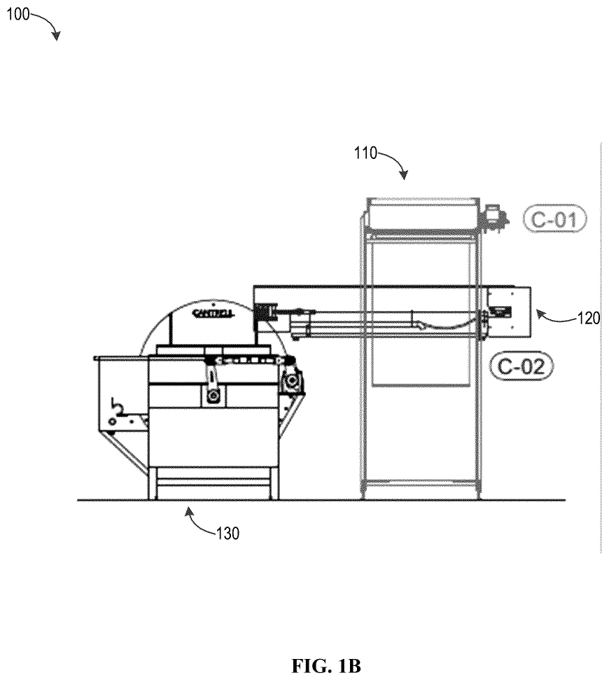

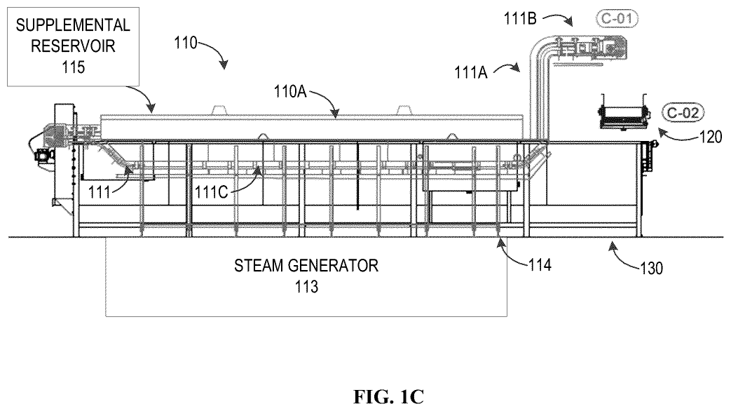

To address the concerns as described above among others, a method and apparatus are presented for providing thermal treatment to the poultry appendages with precisely controlled parameters. In this regard, the apparatus may comprise a thermal transport assembly 110 that may be structured and configured to at least partially submerge the poultry appendages within thermal treatment liquid contained by the thermal transport assembly 110. As illustrated in FIGS. 1A-1C, and discussed in further detail below, the thermal transport assembly 110 receives poultry appendages from a supply device (e.g., a picker device 101). The transport assembly 110 includes a fluid container 110A with the thermal treatment liquid, a transport device 111 (e.g., a conveyor, or the like) for moving the poultry appendages through the thermal treatment liquid (e.g., thus exposing the poultry appendages to the thermal treatment liquid for a target duration), and/or a heater assembly for maintaining the thermal treatment liquid at a target temperature, as will be described in further detail below. After the thermal treatment, the appendages will be subject to further processing (e.g., by a selection element 120, a chiller transport assembly 130, or the like) downstream of the thermal transport assembly 110.

The fluid container 110A of the thermal transport assembly 110 may be a dip tank that is configured to hold the thermal treatment liquid for the thermal heat treatment. The thermal treatment liquid may be, for instance, water or a water-based liquid containing one or more compounds, such as electrolytic salts, antimicrobial and/or antiviral compounds, carbohydrate compounds, and/or the like. That said, it is within the scope of the disclosure for the thermal treatment liquid to be another type of liquid, such as a temperature-regulated oil.

The thermal transport device 111 of the transport assembly 110 is structured and configured to transport the poultry appendages into and out of the thermal treatment liquid stored within the fluid container 110A of the thermal transport assembly. In some embodiments, the transport device 111 may be a conveyor belt 111C structured and positioned such that, when the poultry appendages are placed on the conveyor belt 111C of the thermal transport assembly 110, the poultry appendages are submerged at least partially in the thermal treatment liquid as the poultry appendages move with the rotation of the conveyor belt (e.g., laterally in horizontal direction). In this regard, the conveyor belt may comprise one or more of various mechanisms or components to transport the poultry appendages, where examples of such mechanisms or components may include a series of rollers, where the rollers may be free-rolling or driven (e.g., by one or more motors configured to rotate the driveshafts of one or more of the rollers, or the like).

Alternatively or in addition, the mechanisms or components may comprise a belt configured to rotate in at least a first direction, where the belt may be constructed from one or more types of materials, such as an interlocking or otherwise linked metal, a flexible material or fabric, and/or the like. In some embodiments, the belt may be wrapped around the series of rollers such that when one or more of the rollers are powered to rotate in a first direction, the belt may also rotate in the first direction, thereby transporting products (e.g., the poultry appendages, or the like) in the first direction when the products are placed onto the belt.

The conveyor belt may comprise one or more perforations to allow for improved flow and circulation of thermal treatment liquid around the poultry appendages. The conveyor belt 111C may further comprise a plurality of protrusions (e.g., scoop flights, or the like) where each of the protrusions may be generally perpendicular to the direction of travel of the conveyor belt 111C. In a preferred embodiment, the protrusions may be 6 inches long and be spaced apart from one another by 12 inches. In some embodiments, the fluid container 110A may further be equipped with air agitation piping positioned under the conveyor belt and/or directed to the conveyor belt 111C. Accordingly, when air is passed through the air agitation piping, the poultry appendages are slightly agitated as they move through the dip tank, thereby improving the dispersion of heat around and/or throughout each poultry appendage. In this regard, the air agitation piping may be operatively coupled to one or more air or gas generators, such as ring blowers centrifugal blowers, regenerative blowers, roots blowers, side-channel blowers, positive displacement blowers, and/or the like. The air or gas generators, when operated, may cause air or gas to be pushed through the agitation piping (e.g., through generation of positive pressure through a compressor, or the like) into the thermal treatment liquid within the fluid container 110A.

In some embodiments, the fluid container 110A may be operatively coupled with a dosing system that may be configured to introduce an additive (e.g., food-grade compounds or chemicals, or the like) into the thermal treatment liquid of the fluid container 110A. In this regard, the dosing system may comprise a pump (e.g., a chemical metering pump, or the like) configured to add defined amounts of additive to the thermal treatment liquid (e.g., by injecting the input thermal treatment liquid stream with an additive at a controlled rate for a set amount of time). Accordingly, the additive (which may be in solid or aqueous form) may mix with the thermal treatment liquid in the fluid container 110A to provide various benefits when thermally treating the poultry appendages as described elsewhere herein. In other embodiments, the dosing system may be configured to directly add the additives to the thermal treatment liquid (e.g., by depositing a measured amount of the additive directly into the fluid container 110A). In yet other embodiments, the thermal treatment liquid may be pre-treated with the necessary additives before the thermal treatment process is initiated.

In some embodiments, the additive may include one or more food-grade chemicals or compounds. For instance, in some embodiments, the additive may include a defoamer (e.g., a silicone-based food-grade antifoam compound) that may reduce the amount of foam or air bubbles that may form within the thermal treatment liquid during the thermal treatment process. Other examples of additives may include food-grade preservative compounds, such as antimicrobial or antioxidant compounds (e.g., nitrites, nitrates, ascorbic acid, citric acid, and/or the like).

It should be appreciated that other transport devices 111 may be used in the thermal transport assembly 110. For instance, in some embodiments, the transport device 111 may be an array of paddles or fins that may be moved, rotated, oscillated, or otherwise activated such that the paddles or fins move the poultry appendages through the thermal treatment liquid within the fluid container (e.g., by the paddles contacting the poultry appendages and/or by the paddles indirectly moving the poultry appendages through fluid motion). In other embodiments, the transport device may comprise a perforated container (e.g., a basket, bucket, box, and/or the like) that may, when placed into the thermal treatment liquid, allows the thermal treatment liquid to enter and fill at least a portion of the perforated container. Accordingly, when poultry appendages are placed within the perforated container, the perforated container may be dipped into the thermal treatment liquid and/or moved through the thermal treatment liquid (e.g., using rods, suspension cables, track, rail, and/or the like) to allow the poultry appendages to be at least partially submerged in the thermal treatment liquid for the target duration range of the treatment. In yet other embodiments, the transport device 111 may comprise one or more nozzles fluidly and/or returns connected to a thermal treatment liquid reservoir. In such embodiments, the one or more nozzles may expel liquid into the fluid container to generate a downstream current within the thermal treatment liquid such that the poultry appendages are moved through the fluid container through fluid motion. In yet other embodiments, the transport device 111 may be a perforated wall or rake that may push the poultry appendages through the length of the fluid container 110A.

The poultry appendages may be transferred to the thermal transport assembly 100 from one or more supply devices (e.g., a picker device 101, or the like). The one or more picker devices 101 may use heated, pressurized water to clean the exterior of the poultry appendages before the thermal treatment process. The one or more picker devices may supplier the poultry appendages to the transport device 111 of the thermal transport assembly 110 via a pump (e.g., a sanitary pump). Accordingly, in one embodiment, the poultry appendages may enter the thermal transport assembly 110 at an average internal temperature of about 120 degrees Fahrenheit. That said, the internal temperature of the poultry appendages that enter the thermal transport assembly 110 may range from 0 degrees Fahrenheit to 190 degrees Fahrenheit. In other embodiments, the poultry appendages may be supplied to the transport device 111 through other methods, such as via a hopper, a crane, basket, bucket, chute, or the like.

The temperature of thermal treatment liquid within the thermal transport assembly 110 may be maintained by a heater assembly at a specified temperature (e.g., from 100 degrees Fahrenheit to 212 degrees Fahrenheit). For instance, in one embodiment, the temperature of the thermal treatment liquid may be regulated to a temperature between 140 and 170 degrees Fahrenheit. Accordingly, the heater assembly may comprise one or more temperature regulating elements or heater elements. In some embodiments, the temperature regulating elements may include steam injectors (e.g., steam sparge tubes) operatively coupled to a steam generator 113. The steam injectors may be positioned underneath the transport device 111 (e.g., conveyor belt, or the like) and be structured to inject steam or other liquid in a controlled manner into the interior of the fluid container 110A (e.g., into the thermal treatment liquid), thereby regulating the temperature of the thermal treatment liquid. In some embodiments, the one or more steam injectors may be operatively coupled to a valve (e.g., an automated valve such as a pneumatic modulating control valve, ball valve, butterfly valve, and/or the like), a liquid steam generator, and a temperature controller that may be connected to one or more temperature sensors (e.g., thermocouples, thermistors, infrared, thermometers, NTCs, RTDs, or the like sensors) positioned in the thermal treatment liquid.

It should be appreciated that the heater assembly may include other types of temperature regulating elements, such as heating coils (e.g., electric or fluid coils), heating pads that may be placed on the exterior of the fluid container of the thermal treatment assembly, flame-based heating elements (e.g., a combustible gas-powered burner positioned underneath the fluid container), liquid submersible heating elements, radiators, and/or the like.

Based on the readings from the one or more temperature sensors, a temperature controller may regulate (e.g., activate, deactivate, actuate, or the like) the heater elements of the heater assembly to raise or lower the temperature of the thermal treatment liquid as needed. For instance, in embodiments in which the heater element is a steam injector, if the temperature controller detects that the temperature of the thermal treatment liquid is falling below a specified threshold (e.g., a lower threshold), the temperature controller may cause the valve of each of the steam injectors to open, thereby allowing steam to pass from the steam reservoir, through the valve, and into the thermal treatment liquid contained by the fluid container 110A. In some embodiments, the temperature controller may, upon detecting that the temperature of the thermal treatment liquid has fallen below the specified threshold, activate a notification (e.g., an alarm or alert that is audible, visual, and/or physical, such as a siren, a flashing or strobing light, device vibration, an electronic notification on a user device, or the like) and cause the poultry appendages within the fluid container to be directed to a rejection container for removal from the system. Conversely, if temperature of the thermal treatment liquid rises above the specified threshold (e.g., a upper threshold), the temperature controller may deactivate the heater elements to allow the thermal treatment liquid to cool. For instance, in embodiments in which the heater element is a steam injector, the controller may cause the valve of the steam injector to close, thereby shutting off the injection of steam into the fluid container.

In some embodiments, the fluid container may further be equipped with a safety mechanism that detects whether the transport device 111 (e.g., conveyor belt 111C) is functioning properly (e.g., moving at the desired speed, or the like). If a malfunction is detected with the transport device 111 (e.g., the conveyor belt 111C has stopped, has been broken, is experiencing unusual levels of friction, not moving at the target speed, and/or the like), the safety mechanism may shut off the valves for the steam injectors and activate the notification.

The apparatus may further regulate the levels of the thermal treatment liquid within the fluid container 110A such that the poultry appendages remain submerged in the thermal treatment liquid while being transported through the thermal transport assembly 110. To this end, the fluid container 110A may be operatively coupled to a supplemental liquid supply (e.g., thermal treatment liquid supply). In some embodiments the supplemental liquid supply is a supplemental reservoir 115 containing supplemental thermal treatment liquid. In other embodiments, the supplemental liquid supply is a connection to a continuous liquid supply (e.g., water supply line, or the like). In some embodiments, one or more pumps may be used to transport supplemental thermal treatment liquid to the fluid container 110A. In other embodiments, valves, floats, gravity, pressure, or other types of fluid transfer devices may be used to transport the thermal treatment from the supplemental liquid supply (e.g., supplemental reservoir, or the like) to the fluid container 110A. In some embodiments, the thermal treatment liquid within the supplemental reservoir may, in some embodiments, be maintained at a temperature lower than the target thermal treatment liquid temperature within the fluid container 110A. Continuing the above example, if the target temperature of the thermal treatment liquid within the fluid container is 150-165 degrees Fahrenheit, the thermal treatment liquid within the supplemental reservoir 115 may be maintained at 140 degrees Fahrenheit. The fluid container 110A may be equipped with one or more liquid level sensors (e.g., optical, vibrating, ultrasonic, floats, capacitance, radar, conductive or resistance, or the like sensors) communicatively operatively coupled to a supplemental fill controller, which may in turn be communicatively operatively coupled to the supplemental reservoir 115. If the level of the thermal treatment liquid within the fluid container 110A rises above a target level threshold, the supplemental controller may activate a valve to shut off the flow of supplemental thermal treatment liquid from the supplemental reservoir 115 into the fluid container 110A. Conversely, if the level of the thermal treatment liquid within the fluid container 110A falls below the target level threshold, the supplemental controller may activate the valve to open the flow of supplemental thermal treatment liquid from the supplemental reservoir 115 into the fluid container 110A.

The supplemental controller may further be configured to automatically perform certain emergency functions in the event that the level of the thermal treatment liquid within the fluid container falls below critical levels. For instance, if the level of thermal treatment liquid falls below the protrusions (e.g., scoop flights, or the like) on the conveyor belt, the apparatus may determine that the poultry appendages have not been properly submerged (e.g., fully, majority, or the like) in the thermal treatment liquid. Accordingly, the apparatus may redirect the poultry appendages to a rejection container and activate a notification. If the level of the thermal treatment liquid further falls below the level of the conveyor belt itself, the apparatus may adjust the heating elements (e.g., cause the steam injectors to shut off) to prevent unwanted heating of components of the thermal transport assembly 110 (e.g., the injection of unmodulated steam into the thermal transport assembly, or the like).

The dimensions (e.g., width, length, height, and/or the like) and/or other parameters (e.g., operating parameters) of the components of the thermal transport assembly 110 may be selected based on the target duration of submersion and/or the target internal temperature of the poultry appendages. Continuing the above example, if the thermal treatment liquid is set to about 158 degrees Fahrenheit, the conveyor belt of the thermal transport assembly may have a length of about 25 feet. The average linear speed of the conveyor belt may be maintained at about 2.80 feet per second such that the poultry appendages are submerged for a duration of about 7 minutes and 30 seconds. In such an embodiment, the internal core temperature of the poultry appendages may reach a minimum of 149 degrees Fahrenheit for a minimum duration of 42 seconds. Though the foregoing describes an embodiment of the disclosure, it is within the scope of the disclosure for the various parameters of the method and apparatus to have different values and/or ranges. For instance, in some embodiments, the conveyor belt 111C may have a length that ranges from 10 feet to 100 feet. In other embodiments, the length of the conveyor belt 111C may be between 100 feet and 200 feet. In yet other embodiments, the length of the conveyor belt 111C may be between 2 feet and 10 feet.

In some embodiments, the average linear speed of the conveyor belt 111C may range from 1 foot per second to 10 feet per second. In other embodiments, the average linear speed of the conveyor belt 111C may range from 0.01 feet per second to 0.99 feet per second. In yet other embodiments, the average linear speed of the conveyor belt 111C may range from 10 feet per second to 50 feet per second.

In some embodiments, the temperature of the thermal treatment liquid may range from 85 degrees Fahrenheit to 170 degrees Fahrenheit. In other embodiments, the temperature of the thermal treatment liquid may range from 33 degrees Fahrenheit to 85 degrees Fahrenheit. In yet other embodiments, the temperature of the thermal treatment liquid may range from 170 degrees Fahrenheit to 300 degrees Fahrenheit. In this regard, in a preferred embodiment, the temperature of the thermal treatment liquid may be about 175 degrees Fahrenheit.

In some embodiments, the poultry appendages may be submerged for a duration range of between 1 minute and 30 minutes. In other embodiments, the poultry appendages may be submerged for a duration range of between 1 second and 60 seconds. In yet other embodiments, the poultry appendages may be submerged for a duration range of between 0.5 hours and 24 hours. It should be understood that reference is made to various values and/or ranges with respect to the parameters of the method and apparatus for exemplary purposes only and is not intended to restrict the scope of the disclosure provided herein.

The various parameters associated with the apparatus and the method may be modified in order to balance compliance with heat treatment guidelines with output product quality. For instance, it may be desirable to modify the temperature of the thermal treatment liquid and the speed and/or length of the conveyor belt of the thermal transport assembly such that the poultry appendages remain submerged in the thermal treatment liquid for a specified amount of time, thereby allowing the internal temperature of the poultry appendages to reach a particular threshold for the required amount of time (e.g., an internal temperature of 149 degrees Fahrenheit for 42 seconds). For example, if the temperature of the thermal treatment liquid is about 175 degrees Fahrenheit, the system may be configured such that the appendages remain submerged in the thermal treatment liquid for a duration of about 5 minutes and 30 seconds. Accordingly, it should be appreciated that reference is made herein to particular parameters or parameter ranges (e.g., temperature of the thermal treatment liquid, internal temperature of the poultry appendages, linear speed of the conveyor belt, length and/or width of the conveyor belt and/or fluid container of the thermal transport assembly, temperature of supply and supplemental thermal treatment liquid, thermal treatment liquid levels within the fluid container, and/or the like) for exemplary purposes only and should not be construed as limiting the scope of the disclosure. As such, it should be understood that any of the values and/or ranges stated herein may be altered such that the values and/or ranges may fall outside of, overlap, or fall within any stated ranges. Moreover, it should be understood any of the values described herein may vary by +/−1, 2, 3, 4, 5, 6, 7, 8, 9, 10, 15, 20, 30, 40, 50, 60, 70, 80, 90, 100, percent.

Once the poultry appendages have passed through the thermal treatment liquid, the appendages may be transferred from the transport device 111 (e.g., conveyor belt 111C, or the like) to a chiller transport assembly 130 configured to chill the heat-treated poultry appendages for subsequent evaluation, grading, and packing. In this regard, the chiller transport assembly 130 may comprise a chiller transport device 131 (e.g., a conveyor belt, extendable arm, container, and/or the like) configured to transport and lower the poultry appendages as the poultry appendages are transported through a cooler element of the chiller transport assembly 130. For instance, in one embodiment, the chiller transport device 131 may transport the poultry appendages into and through a refrigerated enclosure (e.g., cooler element) of the chiller transport assembly 131, thereby lowering the temperature of the poultry appendages using refrigerated air. It should be appreciated that other types of cooling methods and/or cooler elements are within the scope of the disclosure, such as passing the poultry appendages through a container filled with a cooling liquid.

In some embodiments, the chiller transport assembly 131 may be configured to provide selection-based approval or rejection of a given batch of heat treated poultry appendages. In such embodiments, the chiller transport assembly 130 may comprise a selection element 120 that may be activated to operate in at least a first mode and a second mode, where the first mode of the selection element 120 causes the batch of poultry appendages to be chilled and prepared for packing, while the second mode of the selection element 120 may cause the batch of poultry appendages to be condemned or discarded (e.g., by being placed into a rejection container). Accordingly, in some embodiments, the selection element 120 may comprise a reversing conveyor, which in turn may be operatively coupled to the chiller transport device 130 and/or the rejection container 140. If the apparatus determines that the poultry appendages have been successfully thermally treated in the fluid container (e.g., the thermal treatment liquid has been maintained at the target temperature, the poultry appendages have been maintained at a target submersion level for the target duration, and/or the like), the reversing conveyor may operate in a first direction such that the poultry appendages may be directed to the chiller transport device 130 to be chilled to a desired temperature (e.g., 32 degrees Fahrenheit to 40 degrees Fahrenheit). Once the poultry appendages are chilled, the appendages may be processed for sale (e.g., the poultry appendages may be batched, graded, packed, weighed labeled, checked for quality, packed in an antimicrobial packaging, and/or the like). However, if the apparatus determines that one or more exceptions or conditions apply to the current batch of appendages (e.g., the appendages were not processed at the target submersion level for the target duration, the temperature of the thermal treatment liquid fell below target temperatures for at least a period of time, and/or the like), the reversing conveyor may operate in a second direction (e.g., the reverse direction of the first direction) to transfer such appendages to the rejection container to be subsequently condemned or discarded.

It should be understood and appreciated that other types of selection elements 120 may be used, such as selectively activatable gates or doors, selectively activatable chutes, a selector partition leading to two different transports (e.g., conveyors), and/or the like. In the manner described above, the apparatus and method provide an efficient, economical, and safe way to thermally treat poultry appendages for effective destruction of harmful microbes without the potentially negative effects on the quality of the product that may be associated with conventional thermal treatment systems and methods.

FIGS. 1A-1C illustrate various perspective views of the apparatus described herein. In particular, FIG. 1A provides a top-down view of the apparatus 100. As seen in FIG. 1A, the apparatus 100 may comprise a thermal transport assembly 110 that is coupled to a picker device 101 and a selection element 120 (e.g., a reversing conveyor) of a chiller transport assembly 130. The thermal transport assembly 110 may comprise a thermal transport device 111 (e.g., a conveyor belt, or other device as described above) that operates in the direction from the picker device 101 to the selection element 120. Accordingly, poultry appendages that are supplied (e.g., pumped, or the like as described above) from the picker device 101 into the thermal transport assembly 110 may be deposited onto the thermal transport device 111 to pass through the thermal treatment liquid contained in the fluid container 110A of the thermal transport assembly 110. The thermal transport device 111 may comprise one or more protrusions 112 (e.g., scoop flights), where each protrusion may be generally perpendicular to the direction of travel of the thermal transport device 111 (e.g., if the direction of travel of the thermal transport device 111 is substantially horizontal, the protrusion extends substantially vertically from the thermal transport device 111). In a preferred embodiment, the protrusions may be 6 inches in length, though it is within the scope of the disclosure for the protrusions to be different lengths (e.g., from 4 inches to 36 inches, or other lengths outside of this range). In a preferred embodiment, each of the protrusions 112 may be separated by a distance of 12 inches, though it is within the scope of the disclosure for the scoop flights 112 to be separated by a different distance (e.g., 4 inches to 36 inches, or other lengths outside of this range).

Once the poultry appendages have been passed through the thermal treatment liquid, the poultry appendages may be deposited from the thermal transport device 111 of the thermal transport assembly 110 onto the selection element 120. The apparatus 100 may comprise a controller that controls the direction of the movement of the selection element 120. If the controller detects that the poultry appendages have passed through the thermal transport assembly 110 without any notifications (e.g., an alarm or alert that is audible, visual, and/or physical), the controller may cause the selection element 120 to operate in the direction of a chiller transport assembly 130. In such a scenario, the poultry appendages may be deposited from the selection element 120 onto the chiller transport assembly 130. The chiller transport assembly 130 may comprise a chiller transport device 131 comprising a cooler element (e.g., a conveyor belt that is surrounded by a refrigerated enclosure for at least a portion of the length of the chiller transport device 131). Accordingly, as the poultry appendages move through the chiller transport device 131, the poultry appendages may be cooled to a safe internal temperature for packing (e.g., between 32 degrees Fahrenheit and 40 degrees Fahrenheit). In this regard, the length and operating linear speed of the chiller transport device 131 may be adjusted to allow the poultry appendages to remain within the refrigerated enclosure for a duration that is sufficient for the inner cores of the poultry appendages to reach the target temperatures (e.g., desired safe temperatures). Once chilled to the target temperature, the poultry appendages may be output from the chiller transport device 131 for further processing.

Alternatively, if the controller of the apparatus 100 detects that an exception or failure has occurred during thermal treatment of the poultry appendages, controller may cause the selection element 120 to operate in the direction of a rejection container 140, such that the affected poultry appendages are deposited from the selection element 120 into the rejection container 140. Poultry appendages that are placed into the rejection container 140 may be condemned.

FIG. 1B illustrates a first side perspective view of the apparatus for thermal treatment of poultry appendages, in accordance with an embodiment of the present disclosure. As can be seen in FIG. 1B, the thermal transport assembly 110 may be oriented to be substantially parallel to the chiller transport assembly 130. The distal end of the thermal transport assembly 110 may be operatively connected to a proximal end of the selection element 120, where the distal end of the selection element 120 may be operatively connected to a proximal end of the chiller transport assembly 130.

FIG. 1C illustrates a second side perspective view of the apparatus for thermal treatment of poultry appendages, in accordance with an embodiment of the present disclosure. As seen in FIG. 1C, the thermal transport assembly 110 may comprise a fluid container 110A comprising a bottom member, two sidewall members, and two end members that define an interior space. In this regard, the fluid container 110A may be dimensioned and structured to hold and contain an amount of thermal treatment liquid. The conveyor 111 may run through the fluid container 110A such that any products placed on the conveyor 111 will pass through the thermal treatment liquid contained within the fluid container 110A. Accordingly, the level of the thermal treatment liquid within the fluid container 110A may be regulated by the apparatus 100. In this regard, the fluid container 110A may comprise one or more multi-level liquid sensors configured to detect a level of the thermal treatment liquid within the fluid container 110A. If additional thermal treatment liquid is needed, the additional thermal treatment liquid may be added through the use of a supplemental reservoir 115. Piping or any other liquid conduit may be positioned to fluidly connect the thermal treatment liquid within the supplemental reservoir 115 to the interior of the fluid container 110A. Accordingly, if the sensors (e.g., liquid level sensors) of the fluid container 110A detect that the level of the thermal treatment liquid in the fluid container 110A has fallen below a threshold, the valve associated with the supplemental reservoir 115 may be actuated to allow the thermal treatment liquid from the supplemental reservoir 115 to flow into the fluid container 110A until the specified threshold level is reached.

The thermal transport assembly 110 may further regulate the temperature of the thermal treatment liquid held within the fluid container 110A. In this regard, the fluid container 110A may further comprise one or more temperature sensors configured and positioned such that the fluid level within the fluid container 110A can be determined. Accordingly, if the temperature controller connected to the temperature sensors determines that the temperature of the thermal treatment liquid is falling below the desired threshold level (e.g., a lower temperature threshold), the controller may activate heater elements 114. For instance, the heater elements 114 may include steam injectors fluidly connected to the fluid container 110A (e.g., bottom, side, over the sides), where the heater elements 114 may be fluidly coupled to a steam generator 113. Once activated, the heater elements 114 may inject high-temperature steam (e.g., water that has been heated to a temperature of between 212 degrees Fahrenheit and 450 degrees Fahrenheit) into the fluid container 110A to be mixed with the thermal treatment liquid contained therein. Conversely, if the temperature controller determines that the temperature of the thermal treatment liquid in the fluid container 110A is rising above the desired threshold level, the temperature controller may shut off the heater elements 114 to stop the increase in temperature of the thermal treatment liquid.

In some embodiments, the distal end of the conveyor 111 of the thermal transport assembly 110 may comprise a generally vertical section 111A leading into a generally horizontal section 111B. In such an embodiment, as the poultry appendages move through the fluid container 110A via the thermal transport device 111, the poultry appendages may be supported by the protrusions 112 (e.g., scoop flights) of the thermal transport device 111 as the poultry appendages are lifted upwards through the substantially vertical section 111A to the substantially horizontal section 111B. The selection element 120 may be oriented in a substantially perpendicular manner with reference to the thermal transport assembly 110 and positioned below the distal end of the substantially horizontal section 111B. Accordingly, as the poultry appendages drop-off of the end of the thermal transport device 111 of the thermal transport assembly 110, the poultry appendages may be positioned onto the selection element 120. Furthermore, the chiller transport device 131 may be oriented in a substantially perpendicular manner with reference to the selection element 120 and in a substantially parallel manner with reference to the thermal transport assembly 110. The proximal end of the chiller transport device 131 may be positioned under the distal end of the selection element 120 such that the poultry appendages that drop off of the distal end of the selection element 120 may be deposited onto the proximal end of the chiller transport device 131. In this way, the apparatus 100 provides an automated way to thermally treat poultry appendages and to either chill the poultry appendages for subsequent processing in the case of successful treatment or prepare the poultry appendages for disposal in the case of failed treatment.

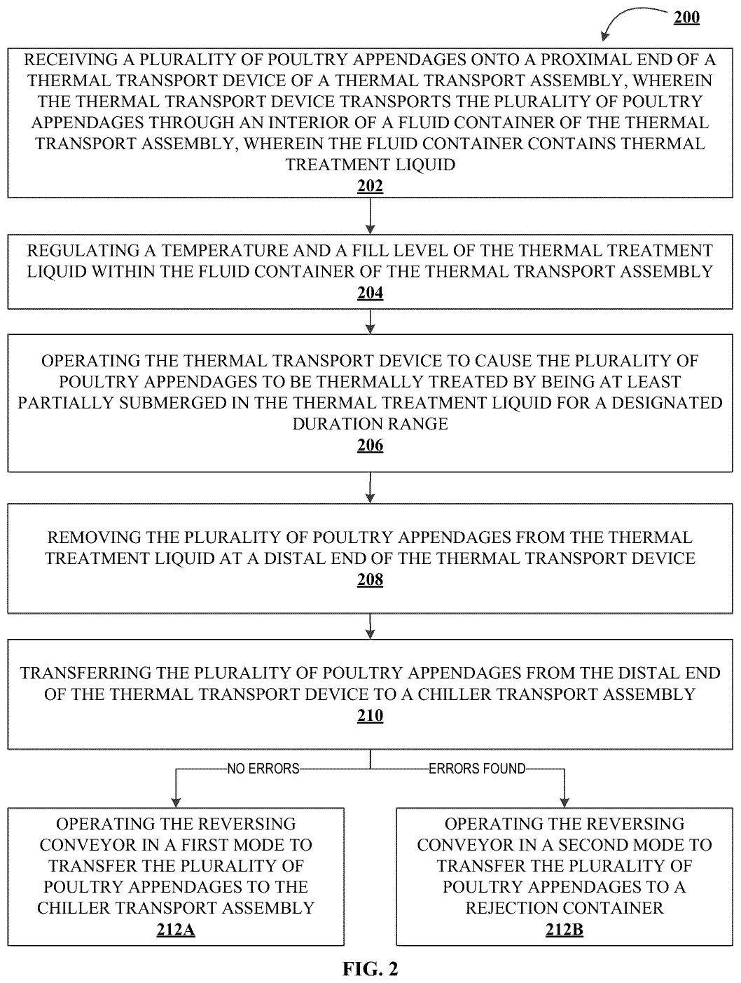

FIG. 2 illustrates a process flow 200 for a method for thermal treatment of poultry appendages. The process begins at block 202, where the method includes receiving a plurality of poultry appendages onto a proximal end of a thermal transport device 111 of a thermal transport assembly 110, wherein the thermal transport device 111 transports the plurality of poultry appendages through an interior of a fluid container 110A of the thermal transport assembly, wherein the fluid container 110A contains thermal treatment liquid. The thermal transport device 111 may be, for instance, a conveyor belt structured and configured to, when activated, transport the plurality of poultry appendages through the thermal treatment liquid. In some embodiments, the poultry appendages (e.g., chicken paws) may be received from a picker device 101 which has been used to preprocess the poultry appendages by applying heated water (e.g., scalding) the exterior of the poultry appendages. In such embodiments, the poul try appendages may be supplied (e.g., pumped using a sanitary pump, or the like) onto the proximal end of the conveyor belt of the thermal transport assembly 110.

The thermal treatment liquid within the fluid container, in some embodiments, may be water or water-based solution that is being held at a target temperature. Accordingly, the dimensions of the fluid container and/or thermal transport device of the thermal transport assembly 110 may be selected based on the number of poultry appendages to be processed and/or the target duration of exposure and submersion of the poultry appendages within the thermal treatment liquid as the poultry appendages move along the thermal transport device 111 through the fluid container 110A. For instance, in a preferred embodiment, the thermal transport device 111 may be 44 inches wide, and the length of the straight section of the thermal transport device may be at least 25 feet. In such a configuration, the apparatus may be able to process 840 poultry appendages per minute. That said, it should be appreciated, as previously discussed herein, that the other thermal transport device lengths (e.g., 4 feet to 100 feet) and/or thermal transport device widths (12 inches wide to 200 inches wide) may be contemplated based on desired processing throughput and/or treatment durations.

The process continues to block 204, where the method includes regulating a temperature and a fill level of the thermal treatment liquid within the fluid container 110A of the thermal transport assembly 110. The fluid container 110A may be equipped with one or more heater elements that may be used to selectively heat the thermal treatment fluid within the fluid container 110A. In this regard, regulating the temperature of the thermal treatment liquid may comprise sensing the temperature of the thermal treatment liquid using one or more temperature sensors within the fluid container. Upon detecting that the temperature of the fluid container is falling below a target temperature threshold, the method may include activating one or more heater elements to increase the temperature of the thermal treatment fluid. For example, in embodiments in which the heater element is a steam injector, activating the heater element may comprise opening a valve fluidly connected to one or more steam injectors positioned at the bottom of the fluid container 110A to introduce steam into the fluid container 110A, thereby raising the temperature of the thermal treatment liquid. On the other hand, if the temperature controller detects that the temperature of the fluid container 110A is rising above the target threshold, the method may include deactivating the one or more heater elements to decrease the temperature of the thermal treatment fluid. Continuing the above example, deactivating the one or more heater elements may comprise closing the valve to the one or more steam injectors to stop the flow of steam into the fluid container, thereby lowering the temperature of the thermal treatment liquid. The temperature threshold for the thermal treatment liquid may be designated based on factors such as the duration of exposure of the poultry appendages to the thermal treatment liquid, the target core temperature for the poultry appendages, the duration at which the poultry appendages will be held at the target core temperature, and/or the like.

In some embodiments, regulating the fill level of the thermal treatment liquid may include detecting the fill level of the thermal treatment liquid using one or more multi-level liquid sensors. If the fill level falls below a designated fill level threshold (e.g., due to evaporative loss, spills, and/or the like), the method may include opening a valve fluidly connected to a supplemental reservoir 115, thereby allowing supplemental thermal treatment liquid to flow from the supplemental reservoir 115 into the fluid container 110A. On the other hand, if it is detected that the fill level is rising above the designated fill level threshold, the method may include closing the valve of the supplemental reservoir 115 to stop the flow of thermal treatment liquid from the supplemental reservoir 115 into the fluid container 110A. The fill level threshold may be set to ensure that the poultry appendages remain sufficiently submerged within the thermal treatment liquid as the poultry appendages move through the thermal transport assembly 110.

The process continues to block 206, where the method includes operating the thermal transport device to cause the plurality of poultry appendages to be thermally treated by being at least partially submerged in the thermal treatment liquid for a designated duration range. For instance, in embodiments in which the thermal transport device 111 is a conveyor belt, the apparatus may control the temperature of the thermal treatment liquid and the average speed of the conveyor belt to control the duration of submersion of the poultry appendages within the thermal treatment liquid. By regulating the temperature of the thermal treatment liquid and the speed of the conveyor belt, the method ensures that the poultry appendages are thermally treated at a constant temperature for a predictable and repeatable duration. Accordingly, the operating speed of the conveyor belt may be selected according to factors such as the length of the section of the conveyor belt that extends through the fluid container, the desired duration of exposure of the poultry appendages to the thermal treatment liquid, and/or the like. In some embodiments, the method may further comprise agitating the poultry appendages as the poultry appendages are submerged in the thermal treatment liquid and/or move through the fluid container by actuating one or more air agitation pipes to introduce air bubbles (or another type of gas) into the thermal treatment liquid, where the air agitation pipes may be positioned proximate to the thermal transport device within the fluid container.

It should be understood that other parameters may be adjusted and controlled by the apparatus in other embodiments. For instance, in embodiments in which the thermal transport device is a selectively submersible basket, the apparatus may control the duration of submersion of the poultry appendages within the thermal treatment liquid by controlling the start time (e.g., the time at which the basket enters the thermal treatment liquid) and stop time (e.g., the time at which the basket is removed from the thermal treatment liquid) of submersion of the submersible basket.

The process continues to block 208, where the method includes removing the plurality of poultry appendages from the thermal treatment liquid at a distal end of the thermal transport device. In this regard, in embodiments in which the thermal transport device is a conveyor belt, the method may comprise lifting the one or more poultry appendages out of the thermal treatment liquid using one or more protrusions 112 (e.g., scoop flights) of the conveyor belt. In such an embodiment, as the poultry appendages approach the distal end of the conveyor belt, the poultry appendages may be supported by the one or more scoop flights through a substantially vertical section of the conveyor belt such that the poultry appendages are lifted above the level of the thermal treatment liquid within the fluid container. In other embodiments (e.g., in embodiments in which the thermal transport device is a basket), removing the poultry appendages from the thermal lifting or moving the submersible basket containing the poultry appendages out of the thermal treatment liquid.

The process continues to block 210, where the method includes transferring the plurality of poultry appendages from the distal end of the thermal transport device to a chiller transport assembly 130. In embodiments in which the thermal transport device is a conveyor belt, the distal end of the conveyor belt may comprise a substantially horizontal portion such that as the poultry appendages reach the distal end of the conveyor belt, the poultry appendages are allowed to drop off-of the conveyor belt of the thermal transport assembly onto a selection element 120 of the chiller transport assembly (e.g., a reversing conveyor). The reversing conveyor may be configured to operate in a first operational mode in which the reversing conveyor transports products in a first direction (e.g., toward a distal end of the reversing conveyor), or a second operational mode in which the reversing conveyor transports products in a second direction that is opposite of the first direction (e.g., toward a proximal end of the reversing conveyor). In this regard, the distal end of the reversing conveyor may be connected to a chiller transport device (e.g., a chilled conveyor belt) of the chiller transport assembly, while the proximal end of the reversing conveyor may be connected to a rejection container. Accordingly, the operational mode of the reversing conveyor may be selected depending on whether any errors were detected during the thermal treatment process, as described below and elsewhere herein.

If no errors have been detected during the thermal treatment process, the process continues to block 212A, where the method includes operating the reversing conveyor in a first mode to transfer the plurality of poultry appendages to the chiller transport assembly 130. In such an embodiment, the apparatus may have detected that the poultry appendages have remained within the thermal treatment liquid for the required duration, the thermal treatment liquid has been maintained at an acceptable operating temperature, that the thermal transport device 111 of the thermal transport assembly 110 has been operating without issues (e.g., the conveyor belt has operated consistently at the designated speed), and/or the like. In such an embodiment, operating the reversing conveyor in the first mode may cause the poultry appendages to be transferred from the distal end of the reversing conveyor onto a proximal end of the chiller transport device 130. The method may then further comprise transporting the poultry appendages through a refrigerated enclosure of the chiller transport device 131 to lower the internal temperature of the poultry appendages to a threshold chilling temperature. Once the poultry appendages have been chilled, the poultry appendages may be batched, sized, and packed for shipping and/or distribution.

However, one or more errors were detected during the thermal treatment process, the process continues to block 212B, where the method includes operating the reversing conveyor in a second mode to transfer the plurality of poultry appendages to a rejection container 140. Examples of such errors may include detecting that the temperature of the thermal treatment liquid has fallen below a defined threshold temperature, that the level of the thermal treatment liquid within the fluid container has fallen below a defined threshold level, that the thermal transport device of the thermal transport assembly is experiencing a malfunction (e.g., the conveyor belt is encountering an unusual amount of friction, the conveyor belt has stopped or has been broken, and/or the like), and/or the like. In response to detecting an error, the method may further comprise initiating a shutdown of the one or more heater elements of the thermal transport assembly 110 and/or activating a notification (e.g., an alarm), where the notification may include an audible alert (e.g., a siren), a visual alert (e.g., a flashing or strobing light), a physical alert (e.g., user device that vibrates), a electronic message (e.g., on a computer device), or the like. If an error is found, the poultry appendages may be deemed to be unsafe for consumption. Accordingly, such poultry appendages may be transported from the proximal end of the reversing conveyor into the rejection container for subsequent disposal. In this way, the method provides a way to automatically perform thermal treatment of poultry appendages while maintaining high operational throughput and maximizing the quality of the resulting product by minimizing the negative effects of the thermal treatment on the poultry appendages.

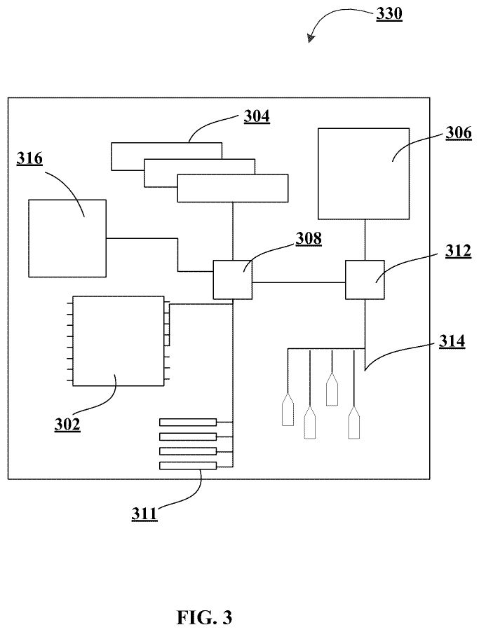

FIG. 3 illustrates a schematic diagram of an exemplary controller system 330 of the apparatus for thermal treatment of poultry appendages, in accordance with one embodiment of the present disclosure. As discussed elsewhere herein, the controller system 330 may be communicatively coupled to one or more sensors (e.g., temperature sensors, fill level sensors, or the like) and one or more activatable elements (e.g., the heater elements, supplemental reservoir valves, agitation piping vales, or the like). In this regard, the controller system 330 may receive information from the one or more sensors and based on the information from the one or more sensors, activate the one or more activatable elements to facilitate the thermal treatment process. In some embodiments, the controller system 330 may further be communicatively coupled to the thermal transport device 111 and/or one or more alarm systems, as described previously.

Accordingly, the controller system 330 may include a processor 302, memory 304, input/output (I/O) device 316, and a storage device 306. The controller system 330 may also include a high-speed interface 308 connecting to the memory 304, and a low-speed interface 312 connecting to low speed bus 314 and storage device 306. Each of the components 302, 304, 308, 310, and 312 may be operatively coupled to one another using various buses and may be mounted on a common motherboard or in other manners as appropriate. As described herein, the processor 302 may include a number of subsystems to execute the portions of processes described herein. Each subsystem may be a self-contained component of a larger system (e.g., controller system 330) and capable of being configured to execute specialized processes as part of the larger system.

The processor 302 can process instructions, such as instructions of an application that may perform the functions disclosed herein. These instructions may be stored in the memory 304 (e.g., non-transitory storage device) or on the storage device 310, for execution within the controller system 330 using any subsystems described herein. It is to be understood that the controller system 330 may use, as appropriate, multiple processors, along with multiple memories, and/or I/O devices, to execute the processes described herein.

The memory 304 stores information within the controller system 330. In one implementation, the memory 304 is a volatile memory unit or units, such as volatile random access memory (RAM) having a cache area for the temporary storage of information, such as a command, a current operating state of the apparatus or controller system 330, an intended operating state of the apparatus or controller system 330, instructions related to various methods and/or functionalities described herein, and/or the like. In another implementation, the memory 304 is a non-volatile memory unit or units. The memory 304 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 304 may store, recall, receive, transmit, and/or access various files and/or information used by the controller system 330 during operation.

The storage device 306 is capable of providing mass storage for the controller system 330. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 304, the storage device 306, or memory on processor 302.

The high-speed interface 308 manages bandwidth-intensive operations for the controller system 330, while the low speed controller 312 manages lower bandwidth-intensive operations. Such allocation of functions is exemplary only. In some embodiments, the high-speed interface 308 is coupled to memory 304, input/output (I/O) device 316 (e.g., through a graphics processor or accelerator), and to high-speed expansion ports 311, which may accept various expansion cards (not shown). In such an implementation, low-speed controller 312 is coupled to storage device 306 and low-speed expansion port 314. The low-speed expansion port 314, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The controller system 330 may be implemented in a number of different forms. For example, the controller system 330 may be implemented as a single board computer (“SBC”), system-on-chip (“SoC”), Internet-of-things (“IoT”) device, or the like. In other embodiments, the controller system 330 may be implemented as a standard server, or multiple times in a group of such servers. Additionally, the controller system 330 may also be implemented as part of a rack server system or a personal computer such as a laptop computer. Alternatively, components from controller system 330 may be combined with one or more other same or similar systems and an entire controller system 330 may be made up of multiple computing devices communicating with each other.

### Testing Data

To validate the thermal treatment process described herein, multiple independent tests were conducted on a number of chicken paw samples to determine the maximum internal temperature (“MIT”) of previously treated samples. The samples were tested according to the USDA's coagulation test for determining maximum internal temperature. In this regard, sample proteins were extracted in a 0.9% saline solution, and heat was applied to the filtrate until the first signs of cloudiness appeared in the filtrate. The temperature at which the cloudiness first appears may be referred to as the “maximum internal temperature.”

TABLE 1
Results of Maximum Internal Temperature
Testing using the Coagulase Method

| Testing date | Number of test samples | MIT (degrees F.) |
|---|---|---|
| Jul. 14, 2023 | 6 | >200 |
| Jul. 21, 2023 | 2 control, | 125.6 (controls), |
| | 8 experimental | >200 experimental |
| Jul. 24, 2023 | 2 control, | 84.2 (ctrl1), 87.8 (ctrl2) |
| | 8 experimental | >200 experimental |
| Jul. 27, 2023 | 8 | >200 |
| Jul. 29, 2023 | 8 | >200 |

As seen in Table 1 above, five separate tests were conducted on multiple different sets of samples. The MIT for each of the experimental samples in all five tests were greater than 200 degrees F., which indicates that the samples were thermally treated to the standards described herein.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

What is claimed is:

1. An apparatus for thermal treatment of poultry appendages, wherein the apparatus comprises:
a thermal transport assembly comprising:
a fluid container defining an interior space configured to contain a thermal treatment liquid;
a thermal transport device at least partially within the interior space of the fluid container, wherein the thermal transport device is configured to transport a plurality of poultry appendages through the interior space of the fluid container;
one or more temperature regulating elements operatively coupled to the fluid container, wherein the one or more temperature regulating elements regulate a temperature of the thermal treatment liquid;
one or more liquid level sensors, wherein the one or more liquid level sensors are configured to detect a fill level of the thermal treatment liquid; and
a supplemental thermal liquid supply operatively coupled to the fluid container; and
a controller operatively connected to the thermal transport assembly for operating the thermal transport device, the one or more temperature regulating elements, and the supplemental thermal liquid supply.

2. The apparatus of claim 1, wherein the apparatus further comprises:
a chiller transport assembly comprising:
a chiller transport device for receiving the plurality of poultry appendages from the thermal transport assembly; and
a cooling element operatively coupled to the chiller transport device, wherein the cooling element chills the plurality poultry appendages.

3. The apparatus of claim 2, wherein the chiller transport assembly further comprises:
a selection element that is operable in a first mode and a second mode, wherein the first mode causes the selection element to transfer the plurality of poultry appendages from the thermal transport assembly to the chiller transport device, wherein the second mode causes the selection element to transfer the plurality of poultry appendages from the thermal transport assembly to a rejection container.

4. The apparatus of claim 3, wherein the selection element is a reversing conveyor positioned underneath and proximate to a distal end of the thermal transport device of the thermal transport assembly, wherein a proximal end of the reversing conveyor is operatively connected to the rejection container, wherein a distal end of the reversing conveyor is operatively connected to the chiller transport device.

5. The apparatus of claim 1, wherein the one or more temperature regulating elements comprise:
one or more steam injectors, wherein the one or more steam injectors are fluidly operatively coupled to the fluid container and fluidly operatively coupled to a steam generator; and
a steam injection valve operatively coupled to the one or more steam injectors, wherein the steam injection valve is operatively coupled to the controller and actuated based on receiving a signal from the controller.

6. The apparatus of claim 1, wherein the thermal transport device is a conveyor belt comprising a plurality of protrusions.

7. The apparatus of claim 6, wherein each of the plurality of protrusions are spaced apart from one another by at least 12 inches, wherein the protrusion of each of the plurality of protrusions has a length of at least 6 inches.

8. The apparatus of claim 1, wherein the thermal transport device is a conveyor belt having a width of between 12 to 200 inches, inclusive, and a length of between 4 feet to 100 feet, inclusive.

9. The apparatus of claim 1, wherein the thermal transport device has an average linear speed between 2 feet per second and 4 feet per second, inclusive.

10. The apparatus of claim 1, wherein the controller is configured to control the one or more temperature regulating elements to maintain a temperature of the thermal treatment liquid between 140 degrees Fahrenheit and 170 degrees Fahrenheit, inclusive.
